(19) United States
(12) Patent Application Publication
(10) Pub. No.: US 2021/0165614 A1
(43) Pub. Date: Jun. 3, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Bo LIU, Kanagawa (JP); Megumi YAMAGUCHI, Kanagawa (JP); Takashi KIKUMOTO, Kanagawa (JP); Shingo TAJIMA, Kanagawa (JP); Daisuke NOGUCHI, Kanagawa (JP); Masatake KAWABE, Kanagawa (JP); Shogo ISHIKAWA, Kanagawa (JP)

(73) Assignee: FUJI XEROX CO., LTD., Tokyo (JP)

(21) Appl. No.: 16/853,900

(22) Filed: Apr. 21, 2020

(30) Foreign Application Priority Data
Nov. 29, 2019 (JP) 2019-216236

(51) Int. Cl. G06F 3/12; G06F 16/55

(52) U.S. Cl. CPC G06F 3/1224; G06F 3/1297; G06F 3/1288; G06F 16/55; G06F 3/1219

(57) ABSTRACT

An information processing apparatus includes a processor configured to: acquire (i) integrated data in which data is allocated so as to integrate the data individually created and (ii) configuration information representing an allocation configuration of the data in the integrated data; specify data groups, each having the same data allocation configuration, from the integrated data based on the acquired configuration information; and estimate an attribute value of the integrated data using attribute values in the specified data groups.

### CROSS-REFERENCE TO RELATED APPLICATIONS

This application is based on and claims priority under 35 USC 119 from Japanese Patent Application No. 2019-216236 filed Nov. 29, 2019.

### BACKGROUND

### 1. Technical Field

The present disclosure relates to an information processing apparatus and a non-transitory computer readable medium.

### 2. Related Art

JP-A-2009-282947 discloses a printing control device that predicts a consumption of toners in printing in an image forming apparatus, the printing control device including: a development unit that develops a printing job instructed to be printed in the image forming apparatus into image data; a prediction unit that analyzes image data obtained by developing by the development unit and predicts the consumption of toners in printing; and an output unit that outputs a consumption of toners consumed in the printing job based on the consumption of toners predicted by the prediction unit and a consumption of toners of each page included in the printing job.

### SUMMARY

In some cases, data created individually is integrated, data is allocated, and processing is performed on integrated data obtained by integrating the respective data.

When such integrated data processing is performed in an information processing apparatus, an attribute value of the integrated data is estimated in advance, and a setting value for defining an operation of the information processing apparatus is set or a user is alerted so that the processing is performed without trouble by referring to the estimated attribute value.

However, in the information processing apparatus of the related art, the attribute value of the entire integrated data is estimated by focusing on the start portion of the integrated data, for example, the start page of the integrated data and using the attribute value of the focused data.

In this case, since the integrated data is constituted by allocating plural pieces of data, when the configuration of allocation different from the data focused in the integrated data is included, an error between the attribute value of the integrated data estimated from the attribute value of the focused data and the attribute value of the actual integrated data may increase.

Aspects of non-limiting embodiments of the present disclosure relate to providing an information processing apparatus and a non-transitory computer readable medium capable of accurately estimating an attribute value of entire integrated data as compared with a case of estimating the attribute value of the entire integrated data using data partially taken out from the start portion of the integrated data when processing the integrated data in which individually created data is integrated and the data is allocated.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire (i) integrated data in which data is allocated so as to integrate the data individually created and (ii) configuration information representing an allocation configuration of the data in the integrated data; specify data groups, each having the same data allocation configuration, from the integrated data based on the acquired configuration information; and estimate an attribute value of the integrated data using attribute values in the specified data groups.

### BRIEF DESCRIPTION OF THE DRAWINGS

Exemplary embodiment(s) of the present disclosure will be described in detail based on the following figures, wherein:

FIG. 1 is a diagram illustrating a configuration example of an information processing system;

FIG. 2 is a sequence diagram illustrating an example of a flow of information in the information processing system;

FIG. 3 is a diagram illustrating an example of an imposition configuration in image data;

FIG. 4 is a diagram illustrating another example of the imposition configuration in the image data;

FIG. 5 is a diagram illustrating an example of a configuration information table;

FIG. 6 is a diagram illustrating another example of the configuration information table;

FIG. 7 is a diagram illustrating a configuration example of an electric system in a server;

FIG. 8 is a diagram illustrating a configuration example of an electric system in an image forming apparatus;

FIG. 9 is a flowchart illustrating an example of a flow of imposition processing;

FIG. 10 is a flowchart illustrating an example of a flow of image forming processing according to a first exemplary embodiment; and

FIG. 11 is a flowchart illustrating an example of a flow of image forming processing according to a second exemplary embodiment.

### DETAILED DESCRIPTION

Hereinafter, the present exemplary embodiment will be described with reference to drawings. The same components and the same processing are denoted by the same reference numerals throughout the drawings, and a repetitive description thereof is omitted.

### First Exemplary Embodiment

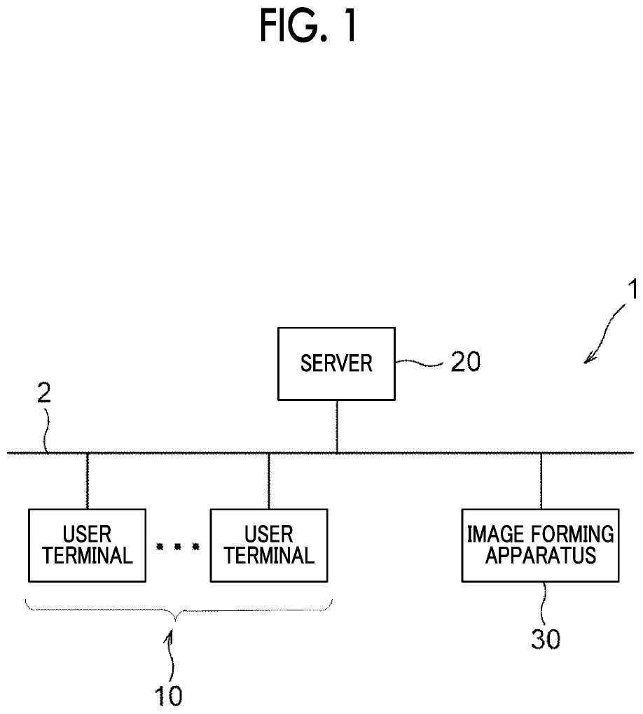

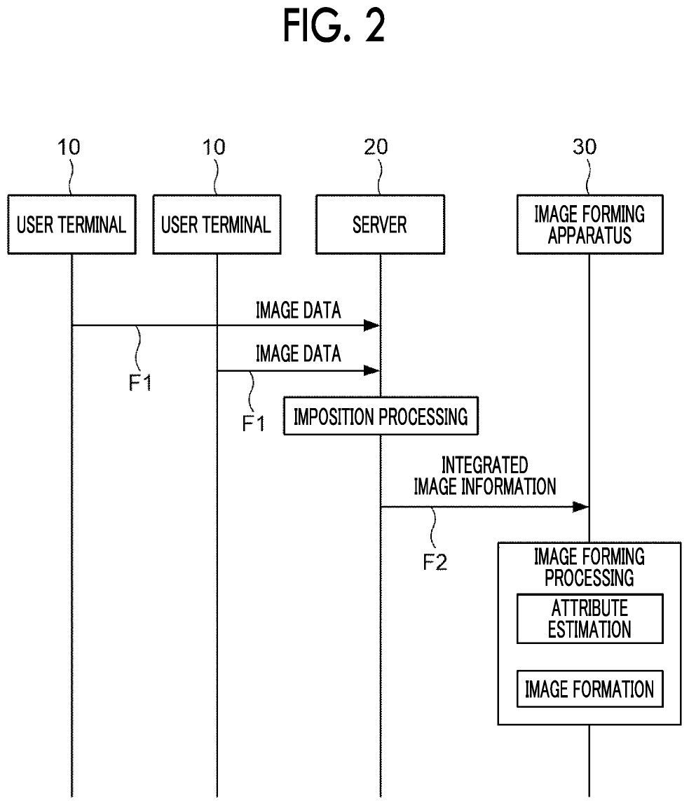

FIG. 1 is a diagram illustrating a configuration example of an information processing system 1 according to the present exemplary embodiment, and FIG. 2 is a sequence diagram illustrating an example of a flow of information in the information processing system 1.

There is no restriction on the type of data handled by the information processing system 1 as long as the information processing system 1 processes integrated data generated by allocating individually created data to a predetermined configuration, but hereinafter, the information processing system 1 will be described by taking the processing of image data as an example.

The data allocation refers to arranging individually created data in a data array or configuration desired by a user or processing data based on a predetermined rule or an instruction from the user. An example of data allocation processing in image data corresponds to, for example, imposition processing. The imposition processing is the processing of arranging plural pieces of individually created image data on a recording medium side by side in accordance with a predetermined rule, a user instruction, a predetermined setting, or the like.

As illustrated in FIG. 1, the information processing system 1 includes a user terminal 10, a server 20, and an image forming apparatus 30, and the user terminal 10, the server 20, and the image forming apparatus 30 are connected to a communication line 2.

The user terminal 10 is an information device for the user to generate image data, and the user terminal 10 transmits the image data specified by the user to the server 20 (see FIG. 2: F1). The image data is data representing an image to be formed on a recording medium such as a sheet in the image forming apparatus 30, and the image data is not limited to an image and may include characters, for example, and further includes layout information of images and characters.

Image data to be formed on a recording medium may be generated as one piece of data, but for example, image data may be generated by sharing image data by plural users, and finally, each image data generated by each user may be integrated, or image data may be generated by a certain user by generating plural pieces of image data and integrating the plural pieces of image data, and such integrated image data may be formed on the recording medium by the image forming apparatus 30. Therefore, the information processing system 1 may include plural user terminals 10, but the number of user terminals 10 included in the information processing system 1 is not limited because each user may share one user terminal 10 and generate image data. Hereinafter, the integrated data is referred to as “integrated data”, and in particular, when the data is image data, the integrated image data is referred to as “integrated image data”.

There is no limitation on the communication protocol used in the communication line 2, and the communication line 2 may be a wired line or a wireless line or may be a line in which a wired line and a wireless line are mixed. Further, the communication line 2 may be a private line or a public line sharing a line with an unspecified number of users such as the Internet.

The server 20 integrates plural pieces of image data received from the user terminal 10 to generate integrated image data. When the image data is data that constitutes a book or booklet, after the folding processing of the recording medium is performed in a bookbinding process, the server 20 arranges each image data on the recording medium such that the image data is arranged in a desired order. Further, even when the server 20 does not constitute a book or a booklet, plural pieces of different image data may be arranged on one recording medium surface and printing may be performed on the image forming apparatus 30. For example, in order to efficiently use the recording medium, the server 20 may control to arrange plural pieces of different image data on the recording medium so that the margin of the recording medium is as small as possible, to cause the image forming apparatus 30 to perform printing and to cut the recording medium so that a printed matter corresponding to each image data is obtained after printing the image. In addition, the server 20 may obtain a printed matter on which an image based on plural pieces of image data is printed on one recording medium surface without cutting the recording medium. The work of arranging the image data on the recording medium for each page in this manner is an example of imposition processing for the integration of the image data executed by the server 20.

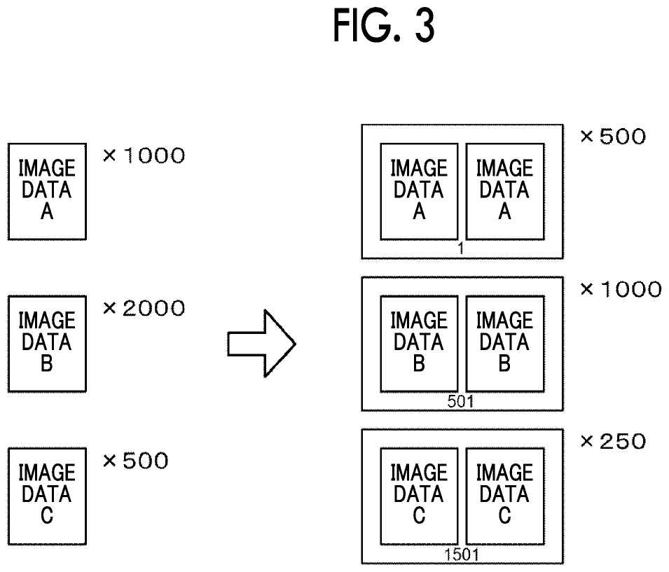

FIG. 3 is a diagram illustrating an example of imposition processing executed by the server 20 and illustrates an example of imposing image data A having 1000 pages, image data B having 2000 pages, and image data C having 500 pages. Specifically, FIG. 3 illustrates an example in which imposition is performed such that pages in which two pages of image data A are arranged per page are arranged from page 1 to page 500 of integrated image data, pages in which two pages of image data B are arranged per page are arranged from page 501 to page 1500, and pages in which two pages of image data C are arranged per page are arranged from page 1501 to page 1750.

The imposition of the image data illustrated in FIG. 3 is an example, and the arrangement position of the image data by the imposition conforms to the imposition information set in advance. The arrangement of the image data specified by the imposition information is not limited, and the server 20 arranges the image data in the arrangement instructed by the user or in the arrangement preset in the server 20.

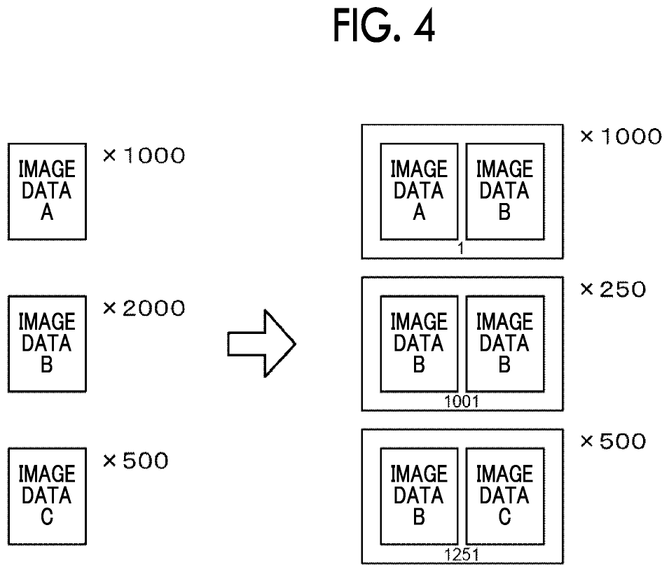

For example, the server 20 may perform imposition processing as illustrated in FIG. 4. FIG. 4 illustrates an example in which imposition is performed such that pages in which the image data A and the image data B are respectively arranged in one page are arranged from page 1 to page 1000 of the integrated image data, pages in which two pages of the image data B are arranged per page are arranged from page 1001 to page 1250, and pages in which the image data B and the image data C are respectively arranged are arranged in one page from page 1251 to page 1750.

Further, the server 20 generates configuration information representing the imposition configuration of the image in the imposition integrated image data.

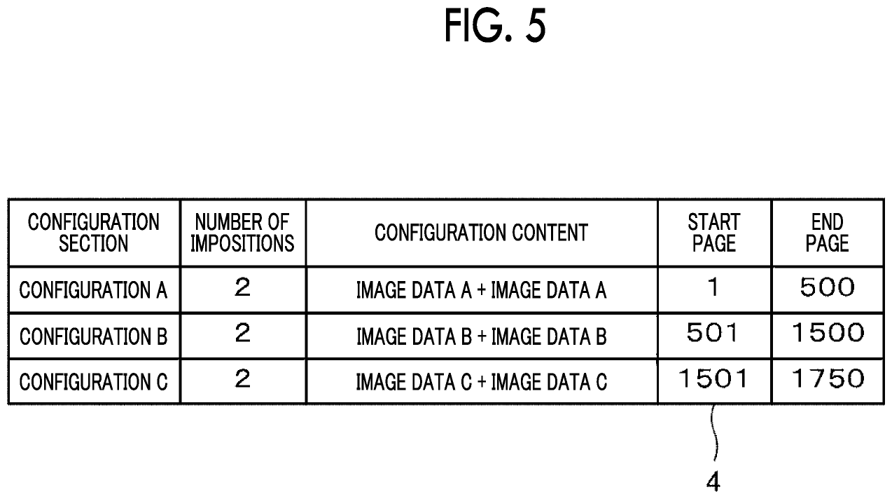

FIG. 5 is a diagram illustrating an example of a configuration information table 4 for managing the configuration information. As illustrated in FIG. 5, the configuration information table 4 includes a configuration section, the number of impositions, a configuration content, a start page, and an end page and manages each piece of configuration information constituting integrated image data in the row direction of the configuration information table 4.

The configuration section is an identifier for identifying pages having the same imposition configuration in the integrated image data. One configuration section constitutes an image data group having the same imposition configuration. The number of impositions represents the number of arrangements of image data per page in the corresponding configuration section. The configuration content represents the type of image data arranged on each page. The start page represents the start page number at which the corresponding configuration section starts in the integrated image data, and the end page represents the page number at which the corresponding configuration section ends.

For example, as illustrated in FIG. 3, when imposition is performed such that two pages of image data A are arranged from the page 1 to the page 500 of integrated image data per page, in the configuration section of the configuration information table 4 in FIG. 5, for example, an identifier “configuration A” is set. Since two pages of image data A are arranged per page in the integrated image data, “2” is set as the number of impositions, and since the types of image data for two pages arranged in each page of the configuration A are both the image data A, “image data A+image data A” is set as the configuration content. Since the image data group of the configuration A constitutes from the page 1 to the page 500 of the integrated image data, “1” is set in the start page, and “500” is set in the end page.

Similarly, in a configuration B, configuration information corresponding to imposition in which two pages of image data B are arranged per page from the page 501 to the page 1500 of the integrated image data is set, and in a configuration C, configuration information corresponding to imposition in which two pages of image data C are arranged per page from the page 1501 to the page 1750 is set.

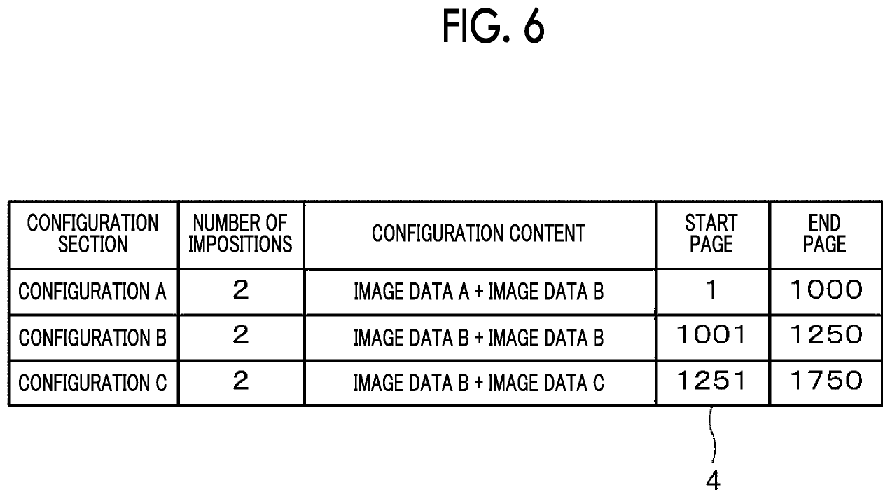

FIG. 6 is a diagram illustrating an example of the configuration information table 4 when the imposition processing as illustrated in FIG. 4 is performed.

When imposition is performed such that the image data A and the image data B are arranged in one page from the page 1 to the page 1000 of the integrated image data, for example, an identifier “configuration A” is set in the configuration section of the configuration information table 4 in FIG. 6. Since the image data A and the image data B are respectively arranged on one page in the integrated image data, “2” is set as the number of impositions, and since the types of the image data arranged in each page of the configuration A are the image data A and the image data B, “image data A+image data B” is set as the configuration content. Since the image data group of the configuration A constitutes from the page 1 to the page 1000 of the integrated image data, “1” is set in the start page, and “1000” is set in the end page.

Similarly, in the configuration B, configuration information corresponding to imposition in which two pages of image data B are arranged per page from the page 1001 to the page 1250 of the integrated image data is set, and in the configuration C, configuration information corresponding to imposition in which image data B and image data C are respectively arranged in one page from the page 1251 to the page 1750 is set. The configuration information table 4 is generated for each integrated image data.

The server 20 transmits integrated image information including the generated integrated image data and configuration information representing the imposition configuration in the integrated image data to the image forming apparatus 30 (see FIG. 2: F2).

The image forming apparatus 30 performs image forming processing for forming an image represented by the integrated image data included in the integrated image information received from the server 20 on a recording medium in accordance with the imposition content specified by the configuration information. There is no restriction on the type of the recording medium used in the image forming apparatus 30, and even if the recording medium is cut paper that is pre-cut to individual sizes such as A4 or A3, continuous paper wound in a roller shape may be used, but here, as an example, the image forming apparatus 30 forms an image on the continuous paper.

Before the image represented by the integrated image data is formed on the recording medium, the image forming apparatus 30 estimates the attribute value of the integrated image data using the attribute value in the image data group for each configuration segment constituting the integrated image data.

The attribute value is a value representing a characteristic of the data, and includes not only a characteristic of the data itself but also a value characterizing processing when the image forming apparatus 30 processes the data.

For example, since the integrated image data is described in a page description language, the image forming apparatus 30 converts the integrated image data into raster image data represented in a bitmap format, and then forms an image. The conversion of the image represented by the integrated image data described in the page description language into information on a set of pixels, that is, a bitmap format so that the image forming apparatus 30 can form an image on the recording medium is referred to as “rasterization”, but the value representing the number of converted pages per unit time when converting integrated image data into raster image data changes depending on the content of the integrated image data. Therefore, the amount of converted data per unit time by rasterization (hereinafter, referred to as “rasterization performance”) is an example of the attribute value of the integrated image data, and for example, a value representing the number of converted pages per unit time, a value representing the number of converted image planes per unit time, a value representing a converted data capacity per unit time, and the like are examples of the attribute value. The rasterization performance may be defined by a transfer data amount (also referred to as a transfer speed) of raster image data that can be transferred in a unit time or may be defined by the amount of data calculated in consideration of the amount of data converted into raster image data per unit time and the transfer speed.

In the present exemplary embodiment, an example in which [page/minute] is used as a unit of rasterization performance will be described, but the display form of rasterization performance is not limited thereto, and for example, the display form of rasterization performance may be expressed by a time required for rasterizing an image for one page ([time/page]), or in particular, when an image is formed on continuous paper, the conversion capability to raster image data may be represented by the length ([m/min]) of continuous paper on which an image can be formed in one minute.

The estimation method of the attribute value of the integrated image data using the estimation of the rasterization performance as an example will be described later in detail.

Based on the estimated attribute value of the integrated image data, the image forming apparatus 30 sets a setting value for defining the operation of the image forming apparatus 30 and alerts the user regarding the image forming processing so that an image represented by the integrated image data is efficiently formed on continuous paper as specified by the user.

Next, a configuration example of the electric system in the server 20 will be described.

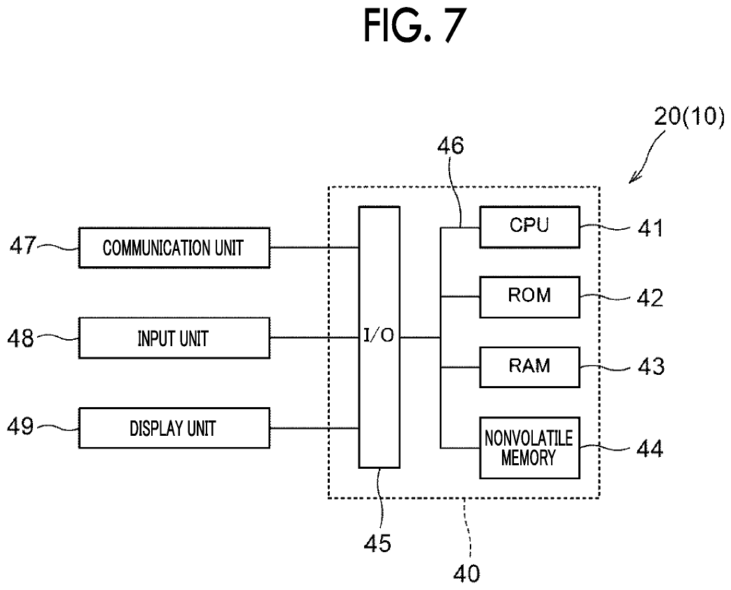

FIG. 7 is a diagram illustrating a configuration example of an electric system in the server 20. The server 20 is implemented by, for example, a computer 40.

The computer 40 includes a central processing unit (CPU) 41 that is an example of a processor that executes predetermined processing of the server 20 according to an information processing program, a read only memory (ROM) 42 that stores the information processing program that causes the computer 40 to function as the server 20, a random access memory (RAM) 43 that is used as a temporary work area of the CPU 41, a nonvolatile memory 44, and an input/output interface (I/O) 45. The CPU 41, the ROM 42, the RAM 43, the nonvolatile memory 44, and the I/O 45 are connected to each other via a bus 46.

The nonvolatile memory 44 is an example of a storage device in which stored information is maintained even if the power supplied to the nonvolatile memory 44 is cut off, and for example, a semiconductor memory is used, but a hard disk may be used. The configuration information table 4 generated by the servers 20 may be stored in the RAM 43 or the nonvolatile memory 44.

On the other hand, a communication unit 47, an input unit 48, and a display unit 49, for example, are connected to the I/O 45.

The communication unit 47 is connected to the communication line 2 and includes a communication protocol for performing data communication between the user terminal 10 and the image forming apparatus 30. External devices (not illustrated) other than the user terminal 10 and the image forming apparatus 30 may be connected to the communication line 2, and the communication unit 47 also includes a communication protocol for performing data communication with such external devices (not illustrated).

The input unit 48 is a device that receives an instruction from the user and notifies CPU 41 of the instruction. For example, buttons, a touch panel, a keyboard, and a mouse are used as the input unit 48. When an instruction is received by voice, a microphone may be used as the input unit 48.

The display unit 49 is an example of a device for visually displaying information processed by the CPU 41, and for example, a liquid crystal display, an organic electro luminescence (EL) display, or the like is used as the display unit 49.

The units connected to the I/O 45 are examples, and it is needless to say that units other than the units illustrated in FIG. 7 are connected as required.

The configuration example of the user terminal 10 is also the same as that of the electric system in the server 20 illustrated in FIG. 7. However, in this instance, a user terminal program for causing the computer 40 to function as the user terminal 10 is stored in the ROM 42.

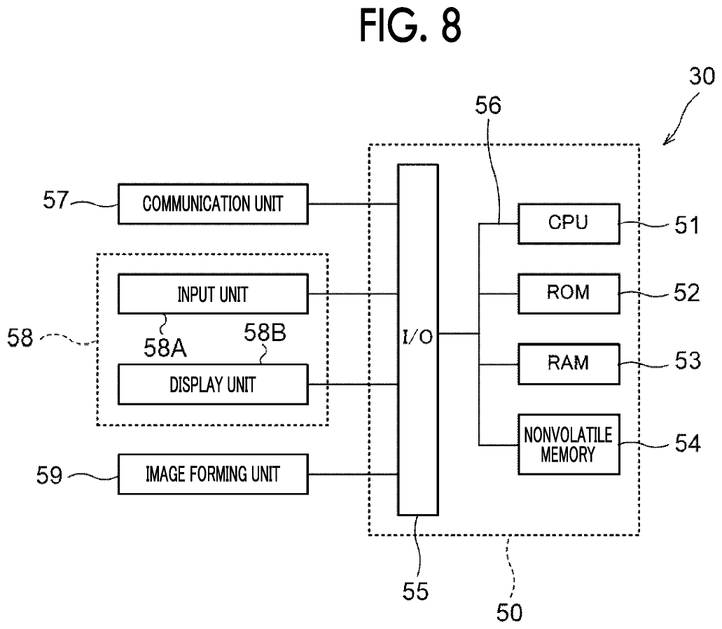

On the other hand, FIG. 8 is a diagram illustrating a configuration example of an electric system in the image forming apparatus 30. The image forming apparatus 30 is implemented by, for example, a computer 50.

The computer 50 includes a CPU 51 that is an example of a processor that executes predetermined processing of the image forming apparatus 30 according to an image forming program, a ROM 52 that stores an image forming program that causes the computer 50 to function as the image forming apparatus 30, a RAM 53 that is used as a temporary work area for the CPU 51, a nonvolatile memory 54, and an I/O 55. The CPU 51, the ROM 52, the RAM 53, the nonvolatile memory 54, and the I/O 55 are connected to each other via a bus 56.

For example, a communication unit 57, an operation unit 58, and an image forming unit 59 are connected to the I/O 55.

Similar to the communication unit 47 of the server 20, the communication unit 57 is connected to the communication line 2 and includes a communication protocol for performing data communication with other devices connected to the communication line 2.

The operation unit 58 provides the user with an interface with the image forming apparatus 30. Specifically, the operation unit 58 includes an input unit 58A and a display unit 58B.

The input unit 58A is a device that receives an instruction from the user and notifies the CPU 51 of the instruction, and includes, for example, buttons, a touch panel, a pointing device, and the like. When an instruction is received by voice, a microphone may be used as the input unit 58A.

The display unit 58B is an example of a device for visually displaying information processed by the CPU 51, and for example, a liquid crystal display, an organic EL display, or the like is used as the display unit 58B.

A touch panel, which is an example of the input unit 58A, is attached to the display unit 58B in an overlapping manner, and when a button on a screen displayed on the display unit 58B is pressed, for example, information on the pressed position is input to the touch panel, and processing corresponding to the button displayed on the pressed position is executed by the CPU 51.

Next, the operation of imposition processing in the server 20 will be described.

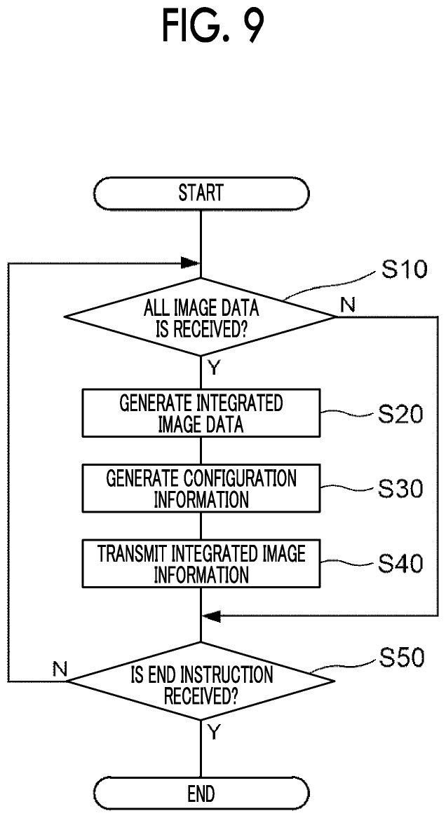

FIG. 9 is a flowchart illustrating an example of the flow of the imposition processing executed by the CPU 41 of the server 20 when the server 20 is started. The server program defining the imposition processing is stored in advance in the ROM 42 of the server 20, for example. The CPU 41 of the server 20 reads the server program stored in the ROM 42 and executes the imposition processing. It is assumed that imposition information is stored in advance in the nonvolatile memory 44 of the server 20.

In step S10, the CPU 41 determines whether or not all the image data constituting the same integrated image data has been received from the user terminal 10.

The image data includes information necessary for imposition such as, for example, an identifier of integrated image data including image data, corresponding imposition information, the number of divisions of integrated image data, and an identifier of image data. Therefore, for example, when image data including an identifier of the same integrated image data is obtained by the number represented by the number of divisions of the integrated image data, the CPU 41 may determine that all the image data constituting the same integrated image data has been received. For example, if the number of divisions of the integrated image data is “3”, it is determined that all the image data constituting the same integrated image data has been received when three types of image data including the identifier of the same integrated image data have been received.

If all the image data constituting the same integrated image data has not been received, the process proceeds to step S50.

In step S50, the CPU 41 determines whether or not an instruction to end the imposition processing has been received from an operator of the server 20. If an instruction to end the imposition processing has not been received, the process proceeds to step S10, and it is determined again whether or not all the image data constituting the same integrated image data has been received from the user terminal 10.

The determination processing of step S10 and step S50 is repeatedly executed until all the image data constituting the same integrated image data are received from the user terminal 10, and when it is determined in the determination processing of step S10 that all the image data constituting the same integrated image data has been received from the user terminal 10, the process proceeds to step S20.

In step S20, the CPU 41 generates integrated image data in which each image data is combined and arranged according to imposition information corresponding to the integrated image data.

In step S30, the CPU 41 generates configuration information representing the imposition configuration of the integrated image data generated in step S20 and manages the generated image data in the configuration information table 4.

In step S40, the CPU 41 transmits the integrated image data generated in step S20 and the integrated image information including the configuration information generated in step S30 to the image forming apparatus 30 via the communication unit 47. As a result, the image forming apparatus 30 executes the image forming processing for the image represented by the integrated image data.

In step S50, as described above, the CPU 41 determines whether or not an instruction to end the imposition processing has been received from the operator of the server 20, and when the instruction to end the imposition processing has not been received, the process proceeds to step S10 to receive image data constituting another integrated image data. On the other hand, when an instruction to end the imposition processing is received, the imposition processing illustrated in FIG. 9 is ended.

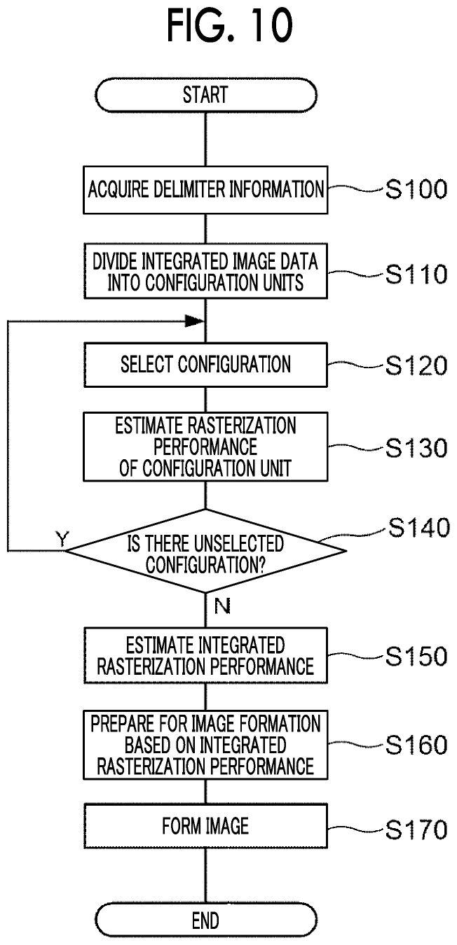

On the other hand, FIG. 10 is a flowchart illustrating an example of the flow of the image forming processing executed by the CPU 51 of the image forming apparatus 30 when the integrated image information is received from the server 20. The information processing program defining the image forming processing is stored in advance in the ROM 52 of the image forming apparatus 30, for example. The CPU 51 of the image forming apparatus 30 reads information processing program stored in the ROM 52 and executes image forming processing.

In step S100, the CPU 51 refers to the configuration information included in the received integrated image information to acquire delimiter information indicating the delimiters of the image data groups constituting the integrated image data. Specifically, the CPU 51 refers to the start page of the configuration information to acquire the page number of the start page in each configuration section in which the imposition configuration changes in the integrated image data as the delimiter information.

In step S110, the CPU 51 specifies image data groups each having the same image imposition configuration from the integrated image data included in the received integrated image information based on the delimiter information acquired in step S100 and divides the integrated image data into configuration sections according to the configuration segments of the image data group. When the configuration information included in the integrated image information conforms to the configuration information table 4 illustrated in FIG. 5 or FIG. 6, the integrated image data is divided into three configurations: a configuration A, a configuration B, and a configuration C.

In step S120, the CPU 51 selects any one of the configurations generated by dividing the integrated image data by step S110 based on the separation information. For the convenience of description, the configuration selected in step S120 is referred to as a “selected configuration”.

In step S130, the CPU 51 estimates the rasterization performance required to rasterize the set of image data group of the selected configuration. Specifically, the CPU 51 actually rasterizes image data corresponding to the preset number of pages among the pages constituted by the image data group of the selected configuration and estimates the rasterization performance of the image data group of the selected configuration. For example, if the preset number of pages (hereinafter, referred to as the “set number of pages”) is set to one page, the CPU 51 rasterizes the image data corresponding to the start page of the pages constituted by the image data group of the selected configuration, acquires the time required to rasterize the image data for one page, calculates the number of pages that can be converted into raster image data in one minute from the acquired time, and estimates the rasterization performance.

The set number of pages is stored in advance in the nonvolatile memory 54 of the image forming apparatus 30, for example, and can be corrected by an administrator of the image forming apparatus 30 or the like. Since the number of pages actually rasterized increases as the set number of pages increases, the estimation accuracy of the rasterization performance for the image data group of the selected configuration increases, while the estimation time required for the estimation of the rasterization performance increases. Therefore, a value considering a trade-off between the estimation accuracy of the rasterization performance and the estimation time of the rasterization performance is set in the set number of pages.

In the above description, as an example, the rasterization performance for the image data group of the selected configuration is estimated by rasterizing the image data corresponding to the set number of pages from the start page of the pages constituted by the image data group of the selected configuration. However, it is not always necessary to perform rasterization from the start page of the image data group, and the rasterization of the image data for the set number of pages may be started from the middle of the pages constituted by the image data group of the selected configuration. A start page for starting rasterization for estimating the rasterization performance of the image data group of the selected configuration is also stored in advance in the nonvolatile memory 54 and can be corrected by the administrator of the image forming apparatus 30 or the like.

After estimating the rasterization performance for the image data group of the selected configuration in this manner, in step S140, the CPU 51 determines whether or not there is an unselected configuration which has not been selected in step S120 among the configurations generated by dividing the integrated image data in step S110. If there is an unselected configuration, the process proceeds to step S120, and the CPU 51 selects any one of the unselected configurations in step S120 and updates the selected configuration. That is, by repeatedly executing the processing of step S120 to step S140 until there is no unselected configuration, rasterization performance is estimated for each image data group constituting the integrated image data.

That is, when the configuration information included in the integrated image information conforms to the configuration information table 4 illustrated in FIG. 5, a rasterization performance R₅ₐₐ for the image data group of the configuration A, a rasterization performance R_{5bb} for the image data group of the configuration B, and a rasterization performance R_{5cc} for the image data group of the configuration C are estimated. When the configuration information included in the integrated image information conforms to the configuration information table 4 illustrated in FIG. 6, a rasterization performance R_{6ab} for the image data group of the configuration A, a rasterization performance R_{6bb} for the image data group of the configuration B, and a rasterization performance R_{6bc} for the image data group of the configuration C are estimated.

In the determination processing of step S140, when it is determined that there is no unselected configuration that has not been selected in step S120 among the configurations generated by dividing the integrated image data by step S110, the process proceeds to step S150.

In step S150, the CPU 51 estimates the rasterization performance (hereinafter, referred to as “integrated rasterization performance”) of the entire integrated image data using the rasterization performance of the respective image data groups constituting the integrated image data estimated in step S130. The setting values that define the operation of the image forming apparatus 30, such as transport speed of continuous paper, are set in accordance with the estimated integrated rasterization performance, but when the largest value among the rasterization performances of respective image data groups constituting the integrated image data is estimated as an integrated rasterization performance, for image data groups other than the image data group to which the largest value of rasterization performance is associated, conversion to raster image data cannot be performed in time at the transport speed of continuous paper. In this case, when the storage area provided in the RAM 53 for transferring the raster image data to the image forming unit 59 becomes empty, the so-called “intermittent printing” occurs, in which the raster image data formed by the image forming unit 59 on the continuous paper disappears and a blank portion appears on the continuous paper.

Therefore, the CPU 51 sets the smallest value of the rasterization performances among the rasterization performances of respective image data groups constituting the integrated image data as an integrated rasterization performance. As a result, an integrated rasterization performance that does not cause intermittent printing can be obtained.

When the configuration information included in the integrated image information conforms to the configuration information table 4 illustrated in FIG. 5, the integrated rasterization performance is expressed by Min (R₅ₐₐ, R_{5bb}, R_{5cc}). When the configuration information included in the integrated image information conforms to the configuration information table 4 illustrated in FIG. 6, the integrated rasterization performance is expressed by Min (R_{6ab}, R_{6bb}, R_{6bc}). The function Min is a function for selecting the smallest value among plural values separated by commas in parentheses.

When the recording medium used in the image forming apparatus 30 is cut paper, intermittent printing does not occur because the transport of the cut paper is stopped until raster image data is generated, even if the largest value among the rasterization performances of respective image data groups is set as an integrated rasterization performance. Instead, compared with the case where the smallest value among the rasterization performances of respective image data groups is set as an integrated rasterization performance, the number of images to be formed per unit time is lowered, and the image forming efficiency is lowered.

In step S160, the CPU 51 sets the setting values defining the operation of the image forming apparatus 30 so that the operation suitable for the integrated rasterization performance is performed, such as setting the transport speed of the continuous paper according to the integrated rasterization performance estimated in step S150 and prepares for image formation.

In step S170, the CPU 51 controls the image forming unit 59 in accordance with the setting values set in step S160 to form an image represented by the integrated image data on continuous paper and ends the image forming processing illustrated in FIG. 10.

In step S130 of FIG. 10, the rasterization performance for each image data group is estimated by actually rasterizing the image data corresponding to the set number of pages, but the rasterization performance for each image data group may be estimated by rasterizing the image data group for a preset period of time, for example, one second.

The CPU 51 may display the integrated rasterization performance estimated in step S150 on the display unit 58B to notify the outside.

As described above, according to the image forming apparatus 30 of the first exemplary embodiment, image data groups having the same imposition configuration are specified from the integrated image data, and an attribute value of the image data group such as a rasterization performance is estimated for each specified image data group. Then, the image forming apparatus 30 estimates the attribute value of the integrated image data using the attribute value of each image data group.

Therefore, the attribute value of the integrated image data is accurately estimated as compared with the case where the attribute value of the entire integrated image data is estimated using the image data partially taken out from the head of the integrated image data without considering the change in the configuration of the integrated image data.

### Second Exemplary Embodiment

In the first exemplary embodiment, an example of estimating an rasterization performance as an attribute value of the integrated image data has been described, but in a second exemplary embodiment, the colorant consumption when the entire image represented by the integrated image data is formed on the recording medium as an attribute value of the integrated image data is estimated.

The colorant is a material used to form an image in a specified color by adhering to a recording medium, and in the image forming apparatus 30 for forming a color image, for example, yellow (Y), magenta (M), cyan (C), and black (K) toners and inks are used as colorants.

Since the configuration example of the information processing system 1 according to the second exemplary embodiment, the flow of information in the information processing system 1, the configuration example of the electric system in the server 20, the configuration example of the electric system in the image forming apparatus 30, and the imposition processing executed by the CPU 41 of the server 20 are the same as in FIGS. 1, 2, 7, 8, and 9, the description thereof will be omitted.

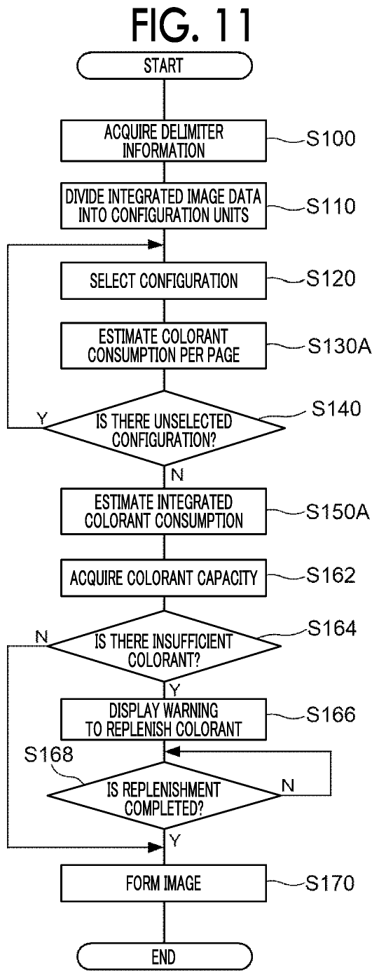

FIG. 11 is a flowchart illustrating an example of the flow of the image forming processing executed by the CPU 51 of the image forming apparatus 30 when the integrated image information is received from the server 20. The image forming processing illustrated in FIG. 11 differs from the image forming processing according to the first exemplary embodiment illustrated in FIG. 10 in that step S130 and step S150 are replaced with step S130A and step S150A, respectively, and the processing of step S162 to step S168 are newly added. Since the other processing is the same as the processing of the image forming processing according to the first exemplary embodiment illustrated in FIG. 10, processing different from the image forming processing according to the first exemplary embodiment illustrated in FIG. 10 will be described below.

After the configuration corresponding to any one image data group is selected in step S120, step S130A is executed.

In step S130A, the CPU 51 actually rasterizes the image data corresponding to the set number of pages among the pages constituted by the image data group of the selected configuration and estimates the colorant consumption per page for each colorant from the obtained raster image data. For example, if the set number of pages is set to three pages, the CPU 51 rasterizes the image data for three pages from the start page of the pages constituted by the image data group of the selected configuration and calculates the colorant consumption of each page for each colorant from the pixel values of each image set for each YMCK. Then, the CPU 51 calculates, for example, the average value of the colorant consumption of each page for each colorant and estimates the colorant consumption per image page constituted by the image data group of the selected configuration.

Here, as an example, the average value of the colorant consumption of each page is set as a colorant consumption per image page constituted by the image data group of the selected configuration, but the colorant consumption per image page constituted by the image data group of the selected configuration may be estimated using other statistics such as the maximum value and the minimum value of the colorant consumption.

Further, as described in the processing of step S130 of FIG. 10, it is not always necessary to rasterize from the start page of the pages constituted by the image data group of the selected configuration, and the rasterization of the image data for the set number of pages may be started in the middle of the pages constituted by the image data group of the selected configuration to estimate the colorant consumption per image page constituted by the image data group of the selected configuration.

By repeatedly executing the processing of step S120 to step S140 until there is no unselected configuration, the colorant consumption per page is estimated for each colorant for each image data group constituting the integrated image data.

When the configuration information included in the integrated image information conforms to the configuration information table 4 illustrated in FIG. 5, a colorant consumption C₅ₐₐ of the cyan colorant, a colorant consumption M₅ₐₐ of the magenta colorant, a colorant consumption Y₅ₐₐ of the yellow colorant, and a colorant consumption K₅ₐₐ of the black colorant per page for the image data group of the configuration A, a colorant consumption C_{5bb} of the cyan colorant, a colorant consumption M_{5bb} of the magenta colorant, a colorant consumption Y_{5bb} of the yellow colorant, and a colorant consumption K_{5bb} of the black colorant per page for the image data group of the configuration B, a colorant consumption C_{5cc} of the cyan colorant, a colorant consumption M_{5cc} of the magenta colorant, a colorant consumption Y_{5cc} of the yellow colorant, and a colorant consumption K_{5cc} of the black colorant per page for the image data group of the configuration C are estimated. Further When the configuration information included in the integrated image information conforms to the configuration information table 4 illustrated in FIG. 6, a colorant consumption C_{6ab} of the cyan colorant, a colorant consumption M_{6ab} of the magenta colorant, a colorant consumption Y_{6ab} of the yellow colorant, and a colorant consumption K_{6ab} of the black colorant per page for the image data group of the configuration A, a colorant consumption C_{6bb} of the cyan colorant, a colorant consumption M_{6bb} of the magenta colorant, a colorant consumption Y_{6bb} of the yellow colorant, and a colorant consumption K_{6bb} of the black colorant per page for the image data group of the configuration B, a colorant consumption C_{6bc} of the cyan colorant, a colorant consumption M_{6bc} of the magenta colorant, a colorant consumption Y_{6bc} of the yellow colorant, and a colorant consumption K_{6bc} of the black colorant per page for the image data group of the configuration C are estimated.

In the determination processing of step S140, when it is determined that there is no unselected configuration that has not been selected in step S120 among the configurations generated by dividing the integrated image data in step S110, the process proceeds to step S150A.

In step S150A, the CPU 51 estimates, for each colorant, the colorant consumption (hereinafter, referred to as “integrated colorant consumption”) when the entire image represented by the integrated image data is formed on continuous paper, using the colorant consumption per page in each image data group estimated in step S130A.

More specifically, the CPU 51 calculates the colorant consumption for each colorant (hereinafter, referred to as “colorant consumption in the image data group”) obtained by multiplying the colorant consumption per page in each image data group constituting the integrated image data by the number of pages of the image constituted by the image data group serving as the estimation target of the colorant consumption. Then, the CPU 51 estimates the integrated colorant consumption for each colorant by adding the colorant consumption in each image data group constituting the integrated image data for each colorant.

When the configuration information included in the integrated image information conforms to the configuration information table 4 illustrated in FIG. 5, the integrated colorant consumption for each colorant is estimated by Equation (1).

$$\begin{matrix}\begin{matrix}\begin{matrix}{C}_{T} = 500 {C}_{5 aa} + 1000 {C}_{5 bb} + 250 {C}_{5 cc} \\ {M}_{T} = 500 {M}_{5 aa} + 1000 {M}_{5 bb} + 250 {M}_{5 cc}\end{matrix} \\ {Y}_{T} = 500 {Y}_{5 aa} + 1000 {Y}_{5 bb} + 250 {Y}_{5 cc}\end{matrix} \\ {K}_{T} = 500 {K}_{5 aa} + 1000 {K}_{5 bb} + 250 {K}_{5 cc}\end{matrix} \} \qquad ( 1 )$$

Here, C_{T} represents the integrated colorant consumption of the cyan colorant, M_{T} represents the integrated colorant consumption of the magenta colorant, Y_{T} represents the integrated colorant consumption of the yellow colorant, and K_{T} represents the integrated colorant consumption of the black colorant.

When the configuration information included in the integrated image information conforms to the configuration information table 4 illustrated in FIG. 6, the integrated colorant consumption for each colorant is estimated by Equation (2).

$$\begin{matrix}\begin{matrix}\begin{matrix}{C}_{T} = 1000 {C}_{6 ab} + 250 {C}_{6 bb} + 500 {C}_{6 bc} \\ {M}_{T} = 1000 {M}_{6 ab} + 250 {M}_{6 bb} + {500}_{6 bc}\end{matrix} \\ {Y}_{T} = 1000 {Y}_{6 ab} + 250 {Y}_{6 bb} + 500 {Y}_{6 bc}\end{matrix} \\ {K}_{T} = 1000 {K}_{6 ab} + 250 {K}_{6 bb} + 500 {K}_{6 bc}\end{matrix} \} \qquad ( 2 )$$

The integrated colorant consumption for each colorant illustrated in Equation (1) or Equation (2) is an estimated value of the colorant consumption consumed by the image forming apparatus 30 when the entire image represented by the integrated image data is formed on continuous paper.

In step S162, the CPU 51 acquires, from the image forming unit 59, a colorant capacity for each colorant included in the image forming apparatus 30.

In step S164, the colorant volume acquired in step S162 and the integrated colorant consumption estimated in step S150A are compared for each colorant. If the colorant capacity of the at least one colorant is less than the integrated colorant consumption, there may be a shortage of colorant during the formation of the image represented by the integrated image data and the formation of the image may stop until, for example, the colorant is replenished. Accordingly, the CPU 51 determines whether or not the colorant capacity of at least one colorant is less than the integrated colorant consumption, that is, whether or not at least one colorant is insufficient. When at least one colorant is insufficient, the process proceeds to step S166.

In step S166, the CPU 51 displays a warning on the display unit 58B that alerts the user to replenish the insufficient colorant. The CPU 51 may give this warning by voice. The replenishment of the colorant includes a form in which the colorant is added to the container containing the colorant, and a form in which the container lacking the colorant is replaced with a new container containing the colorant.

In step S168, the CPU 51 determines whether or not the replenishment of the insufficient colorant has been completed. When the replenishment of the colorant has not been completed, the determination processing of step S168 is repeatedly executed to monitor the replenishment state of the insufficient colorant. On the other hand, when the replenishment of the insufficient colorant is completed, the process proceeds to step S170, and the CPU 51 controls the image forming unit 59 to start forming an image represented by the integrated image data.

When it is determined in the determination processing of step S164 that none of the colorants is insufficient, the process proceeds to step S170 because there is no need to supplement the colorants, and the CPU 51 controls the image forming unit 59 to start forming an image represented by the integrated image data. Thus, the image forming processing illustrated in FIG. 11 is completed.

As described above, according to the image forming apparatus 30 of the second exemplary embodiment, the image data groups having the same imposition configuration are specified from the integrated image data, and the attribute value of the image data group such as the colorant consumption per page is estimated for each specified image data group. Then, the image forming apparatus 30 estimates the colorant consumption per page in each image data group and the colorant consumption consumed by the image forming apparatus 30 for each colorant when the entire image represented by the integrated image data is formed on continuous paper from the number of pages of the image constituted by each image data group.

In the first exemplary embodiment and the second exemplary embodiment, the server 20 performs the imposition processing, but the image forming apparatus 30 may perform the imposition processing. In this case, since the user terminal 10 only needs to transmit the image data to the image forming apparatus 30, the server 20 becomes unnecessary. Conversely, the estimation of the attribute value of the integrated image data in the image forming processing performed by the image forming apparatus 30 may be performed by the server 20. Specifically, for example, the server 20 may execute the processing up to step S150 of the image forming processing according to the first exemplary embodiment illustrated in FIG. 10 and the processing up to step S150A of the image forming processing according to the second exemplary embodiment illustrated in FIG. 11.

The method of estimating the attribute value of the integrated image data from the attribute values of the image data groups having the same imposition configuration is applied not only to the image forming apparatus 30 but also to an information processing apparatus that processes the integrated data in which the data is allocated so as to integrate the individually created data. In this case, the information processing apparatus may acquire integrated data and the configuration information of the integrated data, specify data groups each having the same data allocation configuration from the integrated data based on the configuration information, and estimate the attribute value of the integrated data using the attribute values in the data groups.

The present disclosure has been described using the exemplary embodiments. It is noted that the present disclosure is not limited to the exemplary embodiments. Various changes or improvements can be made to the exemplary embodiments without departing from the gist of the present disclosure, and such changes or improvements are also included in the technical scope of the present disclosure. For example, the order of processing may be changed without departing from the gist of the present disclosure.

In addition, although exemplary embodiments have been described in which the imposition processing and the image forming processing are implemented by software as an example, processing equivalent to the flowcharts illustrated in FIGS. 9 to 11 may be implemented in, for example, an application specific integrated circuit (ASIC), a field programmable gate array (FPGA), or a programmable logic device (PLD), and the processing may be performed by hardware. In this case, the processing speed can be increased as compared with the case where each processing is implemented by software.

In this manner, the CPU 41 of the servers 20 and the CPU 51 of the image forming apparatus 30 may be replaced with a dedicated processor specialized for specific processing, such as an ASIC, FPGA, a PLD, a graphics processing unit (GPU), and a floating point unit (FPU).

The operation of the CPU 41 of the server 20 and the operation of the CPU 51 of the image forming apparatus 30 in the exemplary embodiments may be implemented by plural CPUs 41 and 51, respectively, in addition to the mode implemented by one CPU 41 and the CPU 51. Further, the operation of the CPU 41 of the server 20 and the operation of the CPU 51 of the image forming apparatus 30 in the exemplary embodiments may be implemented by the cooperation of the CPU 41 of the computer 40 located at a physically separated position and the cooperation of the CPU 51 of the computer 50 located at a physically separated position.

In the above-described exemplary embodiments, the ROM 42 and the ROM 52 have programs installed therein, but the present disclosure is not limited thereto. Each program according to the exemplary embodiments can be provided in a form recorded in a computer-readable storage medium. For example, the programs may be provided in a form of being recorded on an optical disc such as a compact disc (CD)-ROM or a digital versatile disc (DVD)-ROM. Further, the programs according to the exemplary embodiments may be provided in the form of being recorded in a portable semiconductor memory such as a Universal Serial Bus (USB) memory or a memory card.

Further, the server 20 and the image forming apparatus 30 may acquire the program from an external device connected to the communication line 2 via the communication unit 47 and the communication unit 57, respectively.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
acquire (i) integrated data in which data is allocated so as to integrate the data individually created and (ii) configuration information representing an allocation configuration of the data in the integrated data;
specify data groups, each having the same data allocation configuration, from the integrated data based on the acquired configuration information; and
estimate an attribute value of the integrated data using attribute values in the specified data groups.

2. The information processing apparatus according to claim 1, wherein
the individually created data is image data, and
the processor is configured to
acquire (i) integrated image data in which page imposition is performed so as to integrate the individually created image data and (ii) the configuration information representing an imposition configuration of images in the integrated image data,
specify image data groups, each having the same image imposition configuration, from the integrated image data based on the acquired configuration information, and
estimate an attribute value of the integrated image data using attribute values in the specified image data groups.

3. The information processing apparatus according to claim 2, wherein
the processor is configured to
estimate, for each image data group as an attribute value in the image data group, a value representing the number of converted pages per unit time when image data is converted into raster image data represented in a bitmap format, and
estimate, as the attribute value of the integrated image data, the number of converted pages per unit time when an entire image represented by the integrated image data is formed on a recording medium using the estimated values representing the numbers of converted pages per unit time in the image data groups.

4. The information processing apparatus according to claim 3, wherein
the processor is configured to
estimate a value representing the number of converted pages per unit time in the image data group, using image data corresponding to the preset number of pages among pages constituted by the image data group.

5. The information processing apparatus according to claim 2, wherein
the processor is configured to
estimate, for each image data group as an attribute value in the image data group, a colorant consumption per page of pages constituted by the image data group, and
estimate, as an attribute value of the integrated image data, a colorant consumption consumed when an entire image represented by the integrated image data is formed on a recording medium from the estimated colorant consumption per page in each of the image data groups and the number of pages of an image constituted by each of the image data groups obtained from the configuration information.

6. The information processing apparatus according to claim 5, wherein
the processor is configured to
estimates a colorant consumption per page in each image data group using image data corresponding to the preset number of pages among pages constituted by the image data group.

7. A non-transitory computer readable medium storing a program that causes a computer to execute information processing, the information processing comprising:
acquiring (i) integrated data in which data is allocated so as to integrate the data individually created and (ii) configuration information representing an allocation configuration of the data in the integrated data;
specifying data groups, each having the same data allocation configuration, from the integrated data based on the acquired configuration information, and
estimating an attribute value of the integrated data using attribute values in the specified data groups.

8. An information processing apparatus comprising:
means for
acquiring (i) integrated data in which data is allocated so as to integrate the data individually created and (ii) configuration information representing an allocation configuration of the data in the integrated data;
specifying data groups, each having the same data allocation configuration, from the integrated data based on the acquired configuration information; and
estimating an attribute value of the integrated data using attribute values in the specified data groups.
